(19) United States
(12) Patent Application Publication
(10) Pub. No.: US 2019/0026482 A1
(43) Pub. Date: Jan. 24, 2019

(54) DEVICE ACCESS CONTROL BASED ON TASK COMPLETION

(71) Applicant: Cogli, LLC, Chicago, IL (US)

(72) Inventors: Brian Kenny, Chicago, IL (US); John McConnell, San Jose, CA (US)

(21) Appl. No.: 16/041,396

(22) Filed: Jul. 20, 2018

Related U.S. Application Data
(60) Provisional application No. 62/536,324, filed on Jul. 24, 2017.

(51) Int. Cl. G06F 21/62; G06F 21/60; G06F 21/31

(52) U.S. Cl. CPC G06F 21/629; G06F 21/604; G06F 2221/2149; G06F 2221/2103; G06F 21/31

(57) ABSTRACT

Systems and devices are disclosed for providing access to selected applications on a user device based on completion of a task related to an education goal. In certain embodiments, questions or other education-related challenges are selected and submitted to a user device. A control device selects certain entertainment-based applications as restricted applications that trigger a separate access-enabling application housed on the user device when access is attempted. The access-enabling application presents the educations questions to the user and selectively permits use of the restricted application based on the response thereto.

### PRIORITY CLAIM

This application claims priority to and the benefit of U.S. Provisional Patent Application No. 62/536,324, filed on Jul. 24, 2017, the entire contents of which are incorporated herein by reference.

### TECHNICAL FIELD

The present disclosure generally relates to controlling access to desired applications on a user device and, more specifically, enabling access based on completion of an education based task by a user of the user device.

### BACKGROUND

The widespread popularity and accessibility of electronic devices has enabled children to spend more and more time in front of screens watching media content, playing games, and otherwise interacting with the electronic devices. In some instances, parents may wish to limit the time spent by their children on entertainment, and increase the time spent on education or other pursuits, or harness their children's desire to use the devices for entertainment as a motivation to also use them to meet educational goals.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for methods, systems, and devices enabling control of a user device. An example system may include a user device comprising at least a first memory, a first transceiver and a first user interface, wherein the first memory contains software code for operating a plurality of entertainment-based applications and operating an access-enabling application that selectively provides user access to a restricted application from among the plurality of entertainment-based applications upon completion of at least a first task relating to an educational goal. The system may also include a server device separate and remote from, but communicatively coupled to, the user device configured to receive educational quizzes from one or more sources, provide a selected educational quiz to the user device, wherein receiving a passing score on the selected educational quiz comprises completion of the first task, and receive, from the user device, data corresponding to usage of the access-enabling application. The system may also include a control device in communication with the server device configured to determine the restricted application, determine one or more tasks for completion, receive, from the server device, data corresponding to usage of the access-enabling application, and filter the educational quizzes from the one or more sources based on the received data and input from a control user.

Example methods and computer readable media may also be included, configured to perform one or more of the steps, functions, and actions of the system described herein.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example simplified block diagram of a system according to embodiments of the present disclosure.

FIG. 2 is a block diagram of an example computing device according to embodiments of the present disclosure

FIG. 3 is a flow chart illustrating certain procedural steps taken by an exemplary system in accordance with the present invention.

FIGS. 4A-4D illustrate an example computing device displaying various permissions options according to embodiments of the present disclosure.

FIGS. 5A-5F illustrate an example computing device displaying various tutoring options according to embodiments of the present disclosure.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

I. Example System

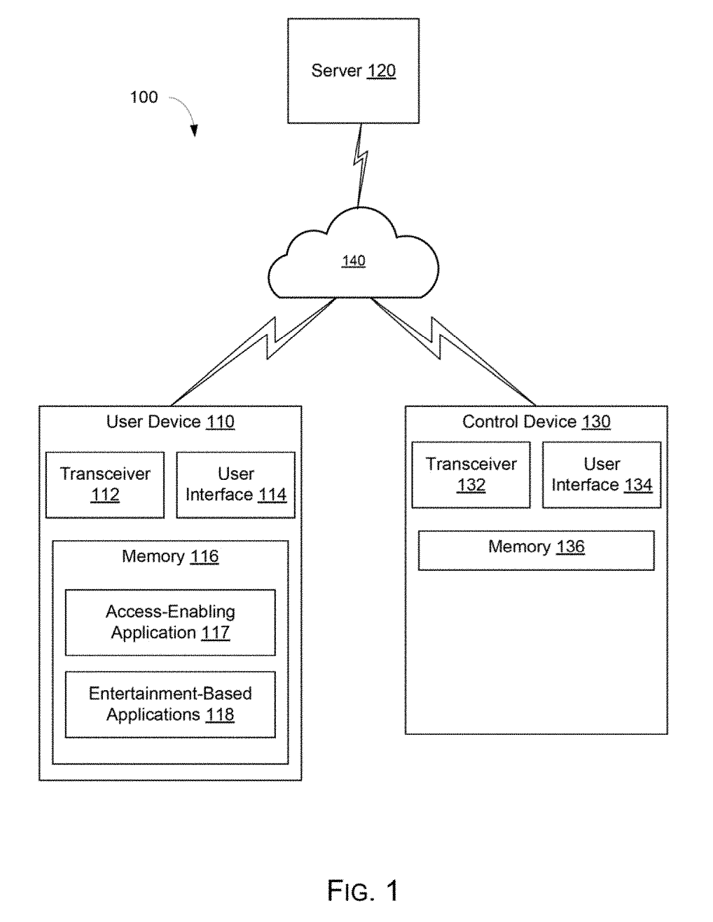

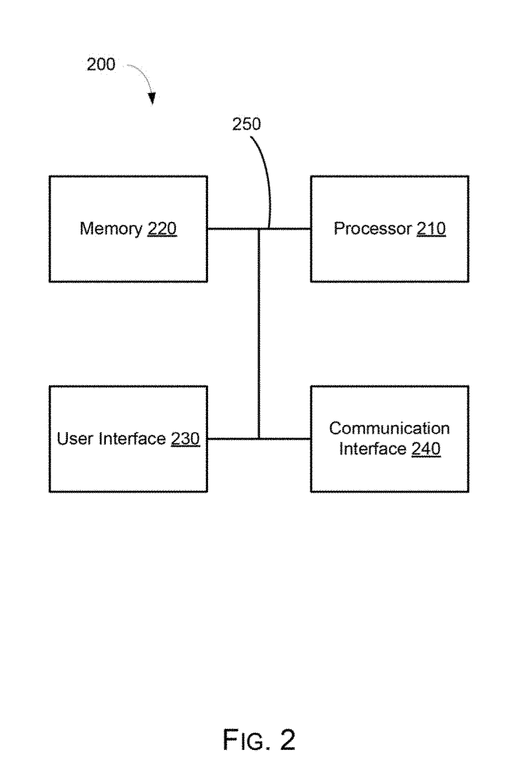

One embodiment of the present invention may take the form of a mobile application configured to operate on a computing device, such as the user device, control device, and/or computing device shown in FIGS. 1 and 2. The mobile application may be a combination of a parental control application and an access-control application. Embodiments described herein may be used in connection with parents and children, such that parents may be able to control their children's usage of entertainment applications on one or more user devices.

While described as a mobile application, it will be understood that the application can alternatively or additionally be accessed via the internet from any computing device with an internet connection and suitable browser software. The term “computing device” is non-limiting, and may be, for example, a smart phone, a laptop, a desktop computer, etc. While the “user device” is typically a specific device belonging to the child (student), the “control device” may be any device through which the parent accesses the application to control the user device. For example, in some embodiments, the control device may be the parent's smart phone with a downloaded application loaded into memory. In other scenarios, the parent may access the access-enabling application housed on a server device via the internet on a different “control device” or via the user device itself. In still further examples, the user device and control device may be the same computing device, such as where a self-directed student chooses to act as his or her own ‘parent’ by self-monitoring his or her own usage, or where a parent grants the child permission to control one or more features described herein.

Embodiments herein may be described with respect to a user device, a server device, and a control device, and may be further described with respect to a child (i.e., a user of the user device) and a parent (i.e., a user of the control device). Some descriptions may refer to actions, functions, features, or allowing/preventing the child, parent, or other actor from carrying out one or more actions. This can be understood as referring to allowing/preventing the user device, server device, and/or control device from carrying out one or more actions. It should also be understood that the usage of parent and child is for descriptive purposes, and other parties, applications, and uses may be included as well.

The access-enabling application may be configured to block the child from using one or more desired applications (such as, e.g., entertainment-based applications, or parts of the applications), and may be controlled by a parent via a control device. This process is discussed in further detail below with respect to FIG. 3. The blocking functionality may include intercepting a child's input on the user device intended to open one or more applications (e.g., a button press, touch, click, or other action), and preventing those applications from being opened. First, a child may attempt to access a particular application, screen, event, or other aspect of an application by tapping, clicking, or otherwise interacting with the user device. Then, rather than opening the intended application, the device may instead display a notification or prompt indicating that the desired application is prohibited (albeit temporarily) until one or more actions are completed. In some instances, only certain aspects of a desired application may be blocked. For example, an entertainment application may be opened to a home screen or default screen, but one or more further screens, games, modes, or other aspects of the entertainment application may be blocked until one or more actions are completed.

The device may then display one or more questions for the child to answer. The child may proceed through the questions by selecting answers, writing in an answer, or otherwise providing input. The access-enabling application may receive the child's input, and may score the accuracy of the input. The access-enabling application may then unlock the desired application (by allowing it to open or start) if a threshold score has been reached. For instance, the child may be presented with a 10 question quiz, and the threshold may be set at 7 points. The child may receive 1 point for a correct answer on a first try for each question, and ¼ of a point for each correct answer on a second try, while receiving 0 points for a correct or incorrect answer on a third try. The sum of the points received may be compared to the threshold value, and when the threshold is reached (either before or after the full 10 question quiz has been taken by the child), the access-enabling application may allow the device to operate the desired application.

One of skill in the art will recognize that the evaluation used to gain access to the desired application on the user device could vary in a number of ways. For example, access could be granted based simply on a correct answer to one question. The question could be part of a quiz that has been selected by the parent, or is at a given level of difficulty. The quiz could comprise multiple questions, and be administered over time, one question at a time, as the user (child) accesses additional desired (blocked) applications, or spends a pre-set amount of time on such applications once access is granted (e.g., to continue such use). In the background, whether on the server or on the user device, the system will keep a “score” that assesses when the user is ready to proceed to the next level of quiz.

In this scenario, while a correct answer may grant access to the desired application, an incorrect answer may provide the user (e.g., “child,” or “student” herein), with options to either enter a study guide to learn more before proceeding, try a new question, or repeat the same question. Depending on settings selected by the parent via the control device, a certain number of incorrect answers may still result in access being granted, but may result in a report being sent to the control device (such as through the server) identifying the event.

The term “quiz,” as used herein, is not intended to be constrained to a particular format or makeup. A quiz simply represents one or more questions asked to determine proficiency. It may be, invariably, referred to as an “assessment” herein.

In some embodiments, a parent may be able to sign up or start a subscription either through downloading the access-enabling application onto their child's device via, for example, the Google Play Store or iTunes, or by signing up for the access-enabling application on a website. Once signed up the parent may download the access-enabling application onto their child's device. And once downloaded onto the child's device, the parent will “enable” the access-enabling application.

Once the access-enabling application is “enabled,” it may act as a combination application blocker and quiz application. By way of example, a child may wish to make a phone call to a friend. The child may press the phone icon on their smart phone, and instead of bringing up the dialer screen where he or she enters in phone numbers, a quiz screen may be displayed on the smart phone. The quiz screen will display a question which may include, but not be limited to, the following formats: multiple choice, fill in the blank, free response typed on phone keyboard, hand written answer which is captured by smart phone camera, and a finger drawing on the phone's surface. The child may be required to answer a question or series of questions correctly before the user device will launch the desired application, in this case, to the phone dialer screen. A similar series of events may apply if the child was trying to access Facebook, Snapchat, Instagram, another social media application, the internet, etc. The quiz screen would display a question that the child would have to answer correctly before they could proceed.

Questions may be selected from a database of questions, which may be sorted according to topic, difficulty, age level, question source, and many other criteria. In some examples, a parent may submit a question or series of questions that can be added to the database, and may be used by one or more other child devices in addition to the child device associated with the particular parent. In some embodiments, the server offers a web-based (or application based) quiz creation portal through which anyone (not just the installer using the control device) can submit material for use in quizzes that, if approved or allowed by system administrators, will be available for all subscribing parents to select from.

If the student answers a question incorrectly, the access-enabling application may display an “incorrect” message with a link to study guide material. The study guide may be a specially created document or series of documents that contain the key points of a quiz lesson—everything the student would need to answer the question(s) contained in a quiz. A student may study this lesson document, which may have a certain lesson theme (for example the theme might be addition or American history), learn the material contained in it, and retake the corresponding blocking quiz. Study Guide material may also include a document related to a specific question, and/or a supplement document which the student may need to reference in order to answer the question. The Study Guide may be displayed as, for example, a .pdf or an embedded website, which may also have interactive capabilities, plain text, and an image or multiple images. Once the student consults the study guide material, they may be able to touch a link to take them back to the question page.

In some embodiments, there may be a question or a series of questions which represents an assessment. A user must score enough points by answering these questions in order to pass the assessment. If the user passes the assessment, the access-enabling application may grant access to the originally intended entertainment-based application. An example of this is described above with respect to the child receiving a threshold amount of points (7 out of 10). A user may be able to submit answers to a question multiple times after reviewing the study guide material, if the question allows. If the question is answered incorrectly, the user may move to the next question and attempt to unlock access to the application again. There may be a limit to the number of times a user may submit answers to a question.

In some examples, the parent may be able to set the threshold specific to a particular series of questions or assessment. For instance, the parent may wish to have a higher or lower threshold for particular topics, subjects, or other categories.

The child device may communicate with the server device in order to receive updates and provide information regarding the quizzes. For instance, the updates may include new questions, new quizzes, new thresholds, new acceptable answers, and more. Via the server, the parent may be able to set a preference for which questions are presented to the child, based on a decided curriculum. The curriculum may be modified by the parent via the control device in order to emphasize one or more topics or types of questions. Further, the child device may transmit information to the server device regarding the child's answers such as how many and which questions were answered correctly, the number and type of quizzes taken, and other metrics related to the child's answers.

On the quiz screen in addition to displaying a question, there may be a “call” button, which may take the student to a different screen with a list of numbers that have previously been approved by the parent to call (e.g., Mom's cell, Dad's Cell, Grandma, 911Emergency, etc.). The access-enabling application registration and setup process may require a parent to enter at least one custom adult phone number. Also a 911Emergency number may be included by default.

A web service or server device may have the ability to track user accounts to a specific device, and additionally keep track of an account's subscription data (e.g., how many months has the user paid for, does the user still have an active (meaning paid for) subscription account, can they still use the access-enabling application's quiz blocking capabilities, have they elected to pay as they go, have they prepaid, will they autopay at the start of every month). The access-enabling application may communicate and check whether an account's subscription is still active with this web service.

In some examples, the system may be able to uniquely identify each smart phone, mobile device, or other user or control devices, and be able to transfer an active (paid for) subscription between two devices. Updates to quiz material and other state changes may be pushed to the devices via a web service.

Before a parent signs up for a subscription, they may create an administrative password, which will allow them to access features of the access-enabling application and the web service that may not be available to their children. The features may be accessed from any web enabled device, such as the control device or the child device. There may be application features, such as a “settings” page, that will only be accessible if the parent's password is entered. Once entered this may allow the parent, via the web enabled device and/or web service, to: (1) search for quizzes (a group of questions with a common theme or subject matter); (2) select one or more quizzes to be used as the blocking quizzes to limit access to desired applications on the user device; (3) activate or deactivate the blocking feature; (4) select which applications (Facebook, Snapchat, etc.) and functions (calling, texting, etc.) will be accessible without having to answer a quiz question; (5) setup a call list of approved numbers; (6) modify account settings (user name, password); and (7) modify Credit Card and Payment data, make a payment or change payment date, and subscription options.

There may be an accompanying website that integrates with the access-enabling application, and is accessible by the control device or another web enabled device. The website may have a parent portal, which is only accessible with the parent's password. Once logged in to the parent's portal, the parent will be able to view, for example, data about the subject, topic, number of questions correct, number incorrect, and total percentage of questions correct for each quiz and types/categories of quizzes. They will also be able to sort data by time (day, last 7 days, past 30 days, and monthly/quarterly/annual/custom time periods). The parent will also be able to view the data for each of multiple devices for which they are a parent (e.g., “Mary's Smartphone” or “Billy's Smartphone”).

The parent may also be able to select a quiz which will be placed on the student's smart phone, based on statistics and usage information provided by a server device. For instance, a control device used by a parent may be able to analyze statistics of usage, topics, etc. of multiple user devices and/or children of the parent, as well as multiple user devices controlled by other parents. This may allow a parent to compare his or her child's progress to aggregate data of children, and select quizzes based on the comparison, and based on global usage, local usage, or other information related to those quizzes used by other children in similar locations, with similar ages, etc.

The quiz selection process may have several drop down menus and fields which the parents can use to sort quizzes quickly, as well as a keyword search feature (e.g., “Subject,” “Topic,” “Grade Level Range,” “Nearby,” etc.). There may be a marketing/shopping cart section that provides images, testimonials, and an opportunity to purchase upgraded software content. A separate webpage may provide a portal for submitting and making new quizzes. There may be an interface for creating and submitting multiple choice quizzes and other quiz/question types. In some embodiments, once a quiz or question is submitted, a website administrator will be able to review the quiz content for appropriateness and approve the quiz. Once approved, a quiz will be sorted according to the categories for which the quiz was designated (e.g., 5^{th} grade, math, algebra, etc.) and made available for paid users of the access-enabling application to select and download to their child's user device.

In some examples, the access-enabling application may provide insightful commentary on a student's performance (e.g., “Sarah is struggling with her Latin verbs, but she is really improving in critical reading”). This may be provided in the form of a computer generated report that is sent via email or accessible via the parent portal of the website via the control device or another computing device. The access-enabling application can enable a control device to review and display data of quiz submission history and discover the learning deficiency areas of the student and automatically add them to the material to be learned.

In some examples, a user may be able to enter a few topic keywords about their learning goals and the access-enabling application will automatically create a curriculum plan from those keywords. For instance, by selecting quizzes from a plurality of authors and sources, which may include those submitted by a plurality of other parents (control devices).

In some examples, the system may be able to track the geolocation of the device and the activity, including where and when a quiz was taken, an entertainment-based application was blocked, and more. The system may also be able to detect and/or prevent a child from uninstalling the access-enabling application, such as by requiring a password to uninstall.

FIG. 1 illustrates an example system 100 according to embodiments of the present disclosure. System 100 may include a user device 110, a server device 120, and a control device 130, all communicatively coupled via a network 140.

User device 110 may include at least one transceiver 112, configured to transmit and receive information via network 140. User device 110 may also include a user interface 114 configured to receive input and provide output from and to a user of user device 110. User device 110 may further include a memory 116. Memory 116 may include computer readable instructions configured to cause one or more functions, actions, and steps to be performed. Memory 116 may store an access-enabling application 117 such as the application described herein, as well as one or more entertainment-based applications 118.

The access-enabling application 117 may selectively provide a user with access to a restricted application from among the plurality of entertainment-based applications upon completion of at least a first task relating to an educational goal. The first task may include completion of a question, completion of a quiz comprising multiple questions, obtaining a predetermined number or percentage of correct answers, selecting “skip” or “pass,” and/or any number of actions such as those described herein. The educational goal may be a goal of improving proficiency in one or more areas, such as math, science, reading, writing, and more. Educational goals may also include reaching a certain level of proficiency in one or more areas, such as completing a level, module, section, or other designated subset of a curriculum. In some examples, the educational goal may be selected by the control device 130, described in more detail below.

Server device 120 may be configured to receive educational quizzes from one or more sources, such as one or more control devices, or from a system administrator. Further, server device 120 may be configured to provide a selected educational quiz to the user device, wherein receiving a passing score on the selected educational quiz, whether all at once or over time, results in a recommendation to move to the next level quiz. And further, server device 120 may receive, from the user device, data corresponding to usage of the access-enabling application, entertainment-based applications, and more. As discussed, in some embodiments, these decisions can be made directly on the server-based application, wherein the control device is merely the computing device being used to access the server, such as via the internet.

Control device 130 may be configured to determine the restricted application or applications for which a task must be completed by the user of the user device. Control device 130 may also be configured to determine the one or more tasks for completion by the user, in particular the quiz, quizzes, or questions that must be answered. Control device 130 may also be configured to receive, from the server device, data corresponding to usage of the access-enabling application, entertainment-based applications, and more.

Control device 130 may further be configured to filter the educational quizzes from the one or more sources based on the received data from the server device and input from a user of the control device 130. This may allow a user of the control device to curate, select, or otherwise determine the tasks that should be completed prior to unblocking the entertainment-based applications. As such, control device 130 may include a transceiver 132, a user interface 134, and a memory 136, which may be configured to carry out the one or more functions or actions described herein.

II. Example Quiz Procedure

In some examples, a quiz may be presented with one or more questions to be answered by a child. Each correct answer on a first try may count as one point, while a correct answer on a second try may count as a quarter of a point. An incorrect answer may count as zero points. A threshold score may be required to pass the quiz, and unblock an application, such as six points, for example.

Again, in some embodiments, a quiz may span several access attempts, where each access attempt only involves presenting, for example, a single question from the quiz (or the quiz is a single question). Access will be granted if the answer to the question is correct, while another question may be presented, or a study guide may be launched, if the answer to the question is incorrect. After a number of separate accesses are attempted (successfully or otherwise), the questions from the quiz will have been rotated through by the access-enabling application and a score can be generated or a report sent to the control device via the server.

An incorrect answer may prompt the display of information corresponding to the question, such as a link to a study guide. The user may select the link, and view the study guide. After viewing the study guide, the user may return to the quiz and either restart the quiz, or pick up where he or she left off.

III. Example Computing Device

FIG. 2 illustrates a simplified block diagram of an example computing device 200 according to embodiments of the present disclosure. User device 110, control device 130 and server 120 are all computing devices. One or more of the user device, server device, and/or control devices described herein may be described with respect to computing device 200. Computing device 200 may be configured for performing a variety of functions or acts, such as those described in this disclosure (and accompanying drawings). The computing device 200 may include various components, including for example, a processor 210, memory 220, user interface 230, and communication interface 240, all communicatively coupled by system bus, network, or other connection mechanism 250.

Processor 210 may include a general purpose processor (e.g., a microprocessor) and/or a special purpose processor (e.g., a digital signal processor (DSP)). Processor 210 may be any custom made or commercially available processor, such as, for example, a Core series or vPro processor made by Intel Corporation, or a Phenom, Athlon or Sempron processor made by Advanced Micro Devices, Inc. In the case where the computing device 200 is a server, the processor 210 may be, for example, a Xeon or Itanium processor from Intel, or an Opteron-series processor from Advanced Micro Devices, Inc. Processor 210 may also represent multiple parallel or distributed processors working in unison.

Memory 220 may include one or more volatile (e.g., random access memory (RAM, such as DRAM, SRAM, SDRAM, etc.)) and nonvolatile (e.g., ROM, hard drive, flash drive, CDROM, etc.), removable, and/or non-removable storage components, such as magnetic, optical, or flash storage, and may be integrated in whole or in part with the processor 210. These and other components may reside on devices located elsewhere on a network or in a cloud arrangement. Further, the memory 220 may take the form of a non-transitory computer-readable storage medium, having stored thereon program instructions (e.g., compiled or non-compiled program logic and/or machine code) that, when executed by the processor 210, cause the device 200 to perform one or more functions or acts, such as those described in this disclosure. Such program instructions may define or be part of a discrete software application that can be executed in response to certain inputs received from the user interface 230 and/or communication interface 240, for instance. Memory 220 may also store other types of information or data, such as those types described throughout this disclosure.

User interface 230 may facilitate interaction with a user of the device, if applicable. As such, user interface 230 may include input components such as a keyboard, a keypad, a mouse, a touch-sensitive panel, a microphone, and a camera, and output components such as a display screen (which, for example, may be combined with a touch-sensitive panel), a sound speaker, and a haptic feedback system. The user interface 230 may also comprise devices that communicate with inputs or outputs, such as a short-range transceiver (RFID, Bluetooth, etc.), a telephonic interface, a cellular communication port, a router, or other types of network communication equipment. The user interface 230 may be internal to the computing device 200, or may be external and connected wirelessly or via connection cable, such as through a universal serial bus port.

Communication interface 240 may be configured to allow the device 200 to communicate with one or more devices (or systems) according to one or more protocols. In one example, the communication interface 240 may be a wired interface, such as an Ethernet interface or a high-definition serial-digital-interface (HD-SDI). As another example, the communication interface 240 may be a wireless interface, such as a cellular or WI-FI interface. In some examples, each of a plurality of computing devices 200 and/or other devices or systems on a network may be configured to use the Internet protocol suite (TCP/IP) to communicate with one another. It will be understood, however, that a variety of network protocols could also be employed, such as IEEE 802.11 Wi-Fi, address resolution protocol ARP, spanning-tree protocol STP, or fiber-distributed data interface FDDI. It will also be understood that while some embodiments may include computing device 200 having a broadband or wireless connection to the Internet (such as DSL, Cable, Wireless, T-1, T-3, OC3 or satellite, etc.), the principles of the invention are also practicable with a dialup connection through a standard modem or other connection means. Wireless network connections are also contemplated, such as wireless Ethernet, satellite, infrared, radio frequency, Bluetooth, near field communication, and cellular networks.

In the context of this document, a “computer-readable medium” may be any means that can store, communicate, propagate, or transport data objects for use by or in connection with the systems and methods as described herein. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and stored in a computer memory. The systems, devices, and methods can be embodied in any type of computer-readable medium for use by or in connection with an instruction execution system or apparatus, such as a computer.

FIG. 3 illustrates a flowchart of an example method 300 of blocking an application according to embodiments of the present disclosure. The flowchart of FIG. 3 is representative of machine readable instructions that are stored in memory and may include one or more programs which, when executed by a processor may cause one or more computing devices or systems to carry out one or more functions described herein. While the example program is described with reference to the flowchart illustrated in FIG. 3, many other methods for carrying out the functions described herein may alternatively be used. For example, the order of execution of the blocks may be rearranged or performed in series or parallel with each other, blocks may be changed, eliminated, and/or combined to perform the disclosed methods. Further, because method 300 is disclosed in connection with the components of FIGS. 1-2, some functions of those components will not be described in detail below.

At block 302, method 300 may include activating the access-enabling application. This may be done in response to receiving input at the control device, or via a web service or other system or device. After activation, the access-enabling application may run on the child device in the background, awaiting input from the child.

At block 304, method 300 may include receiving input from the child. The input may be click or screen tap indicating an intent to open an application or access part of an already open application.

At block 306, method 300 may include comparing the received input to a list of blocked applications or parts of applications. For instance, the parent may block the child's access to certain applications (Facebook, Snapchat, etc.) while allowing access to other applications (maps, notes, etc.). Further, the parent may allow parts of some applications to be accessed, while not allowing complete or full access. As such, block 306 may include determining whether the received input is attempting to access an allowed application or allowed part of an application, or whether the received input is an attempt to access a blocked application or block part of an application. In some embodiments, the system may be configured to simply block all applications on the user device (other than the access granting application).

If the received input is an attempt to access an allowed application, method 300 may proceed to block 308 in which access is allowed. The intended application may be accessed by the child.

But if the input is an attempt to access a blocked application, method 300 may include proceeding to block 310, at which the quiz blocking feature is initiated.

At block 312, method 300 may include presenting one or more questions. This is described in more detail above. At block 314, method 300 may include calculating a score.

At block 416, method 300 may include determining whether the calculated score is greater than a threshold, which may be set by a parent or other party. Where the score achieved by the child is greater than the threshold, method 30 may allow access to the application originally sought by the child (block 308).

But if the score is below the threshold, method 300 may revert to block 312 and may present additional questions, a separate quiz, or further information. In some examples, the child may be presented with a study guide at this stage after he or she has failed to achieve a high enough score. The study guide may be related to the quiz that was just presented and scored. Alternatively, if the achieved score is below the threshold (or if a set number of iterations of quiz taking and scoring have occurred without achieving a threshold score), method 300 may continue to block the sought after entertainment application and end at block 318. This may prevent a child from failing the quiz too many times in a row. In this case, a message will typically be sent to the control device.

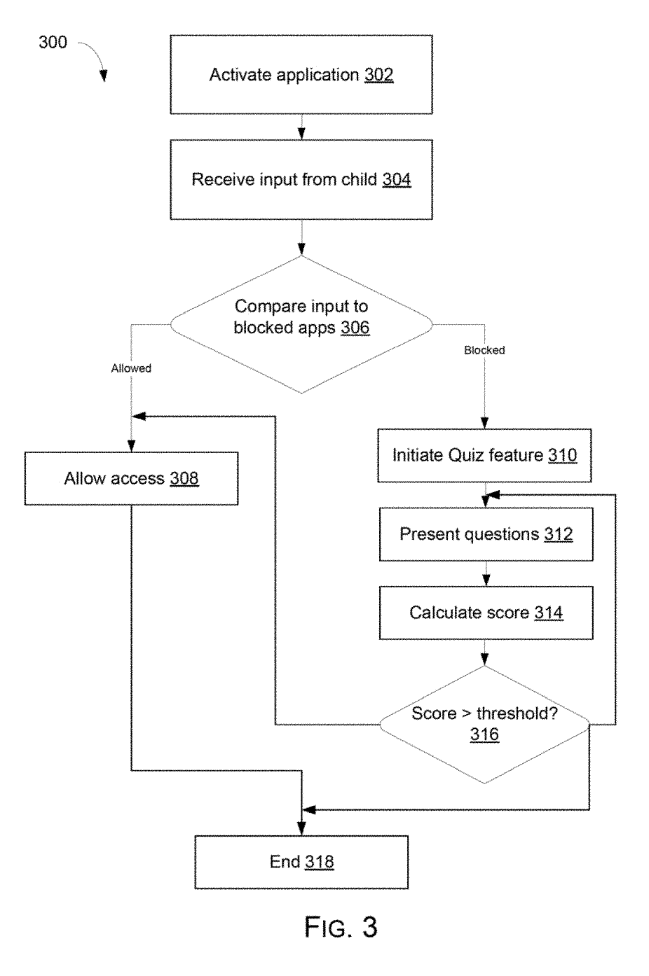

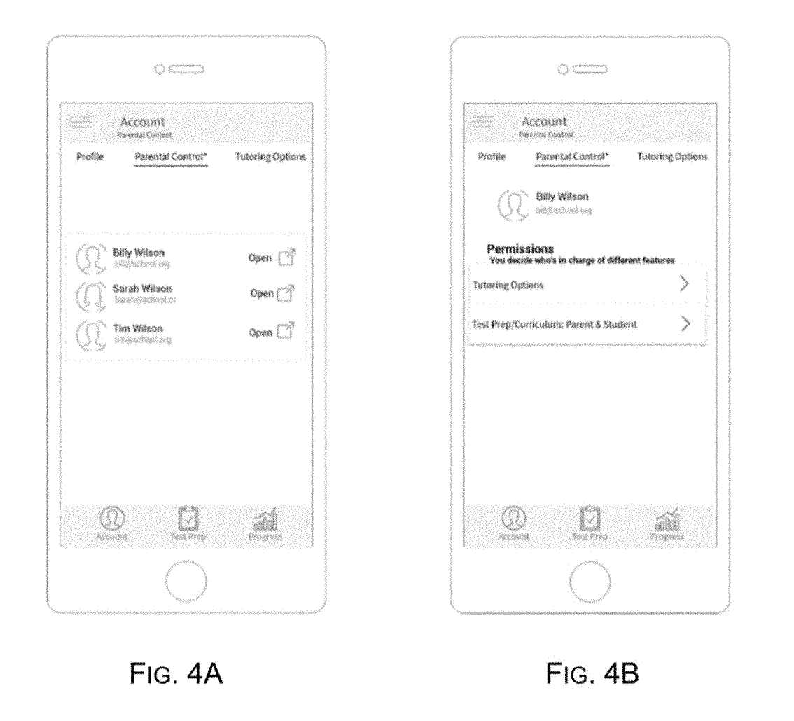

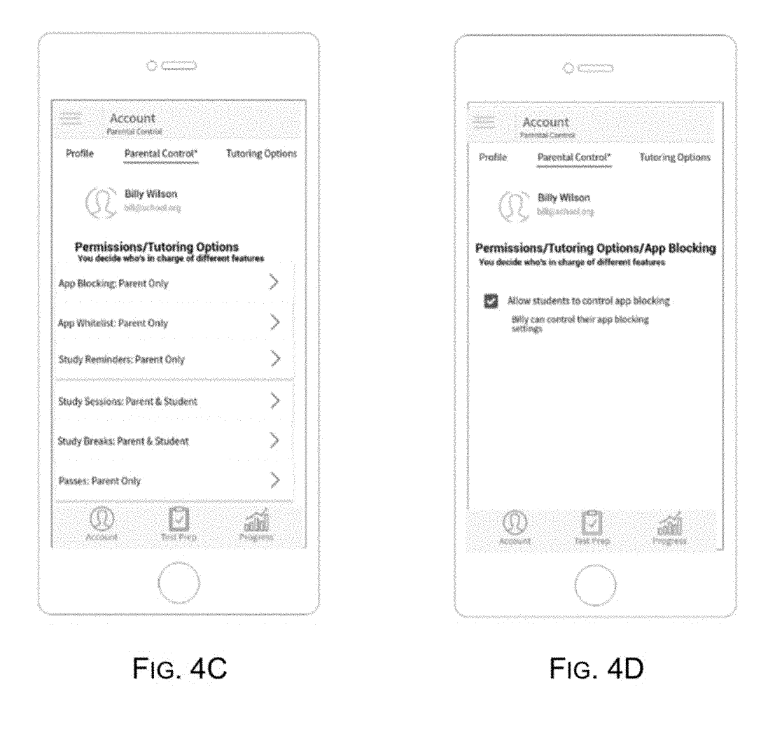

FIGS. 4A-4D illustrate an example computing device displaying various permissions options according to embodiments of the present disclosure. FIG. 4 shows that a control device may be used to access an account corresponding to each child or user device, shown in FIG. 4 as “Billy Wilson,” “Sarah Wilson,” and “Tim Wilson.” After a parent selects the child account (e.g., Billy Wilson), the parent can change one or more permissions options, which may dictate whether the parent or the child (or both) is in control of a given option. This is shown in FIG. 4B.

FIGS. 4C and 4D illustrate that the parent can select whether the parent, child, or both can control whether app blocking is activated (e.g., preventing access to one or more entertainment based application), whether one or more applications or application functions are on a whitelist allowing them to bypass the blocking functionality, various options corresponding to study reminders, study sessions, study breaks, and passes.

In some examples the child may be able to request access or permission for one or more features. The parent, via the control device, may then either decide to enable the child permission or not.

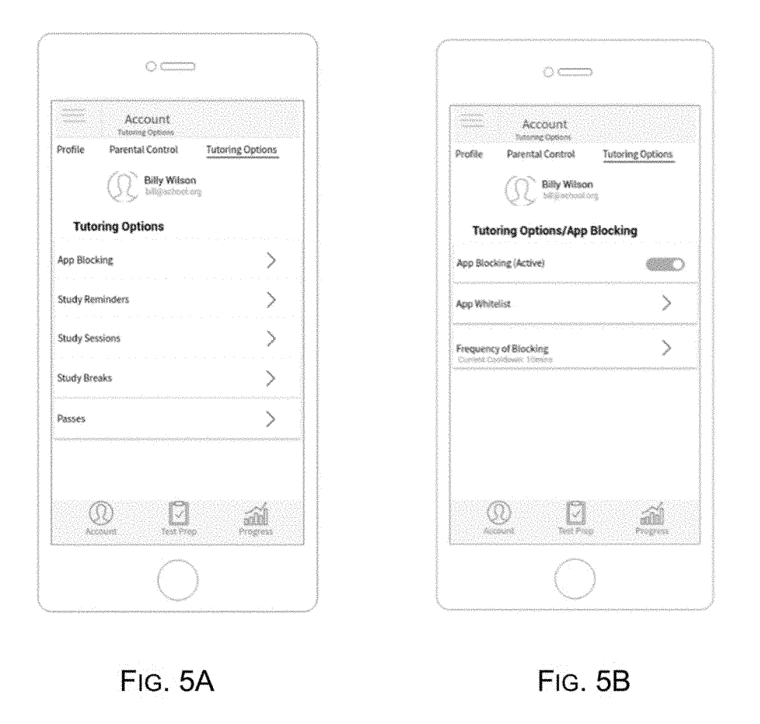

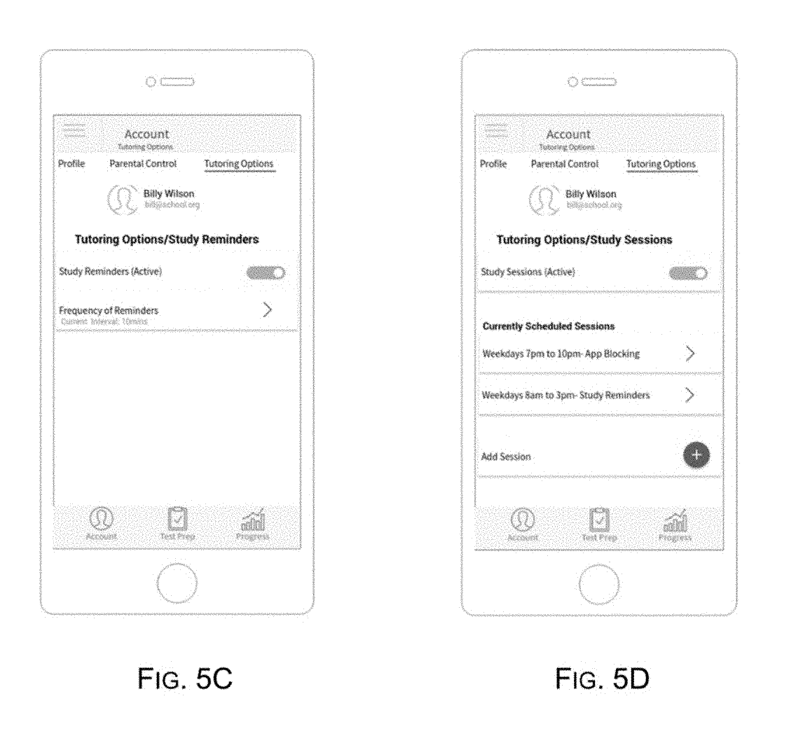

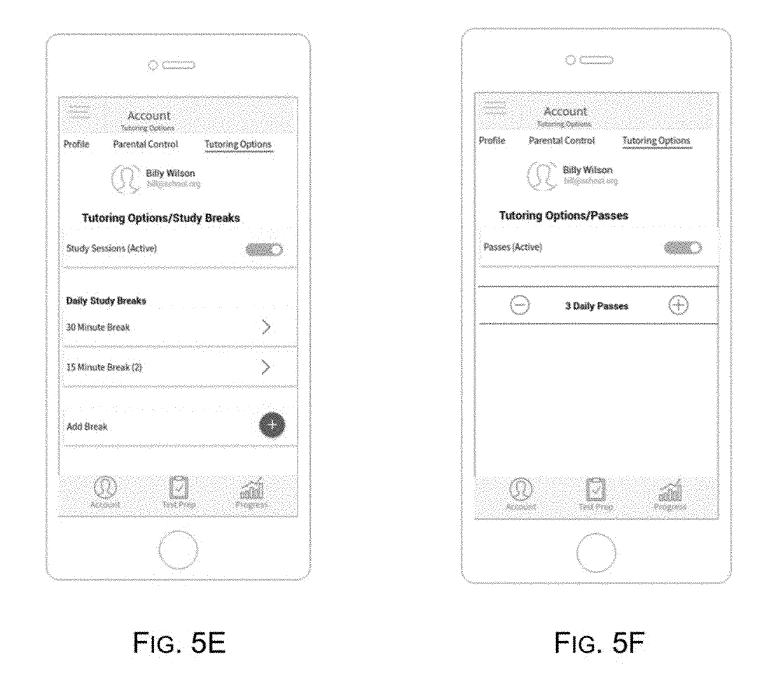

FIG. 5A illustrates several tutoring options available to the child. For example, the tutoring options may include app blocking, study reminders, study sessions, study breaks, and passes. These are shown in FIGS. 5B-5F respectively.

FIG. 5B shows the app blocking feature. When this feature is enabled, it requires the child to complete a task in order to access certain applications. The control device may be used to turn this feature on or off. When app blocking is active, one or more applications may be whitelisted, which allows them to be accessed without requiring completion of a task.

FIG. 5C illustrates a study reminders feature. This feature, when activated, provides the child with reminders to study, and may deactivate app blocking. The study reminders may be delivered to the child at a given frequency, which can be set to various durations such as once every ten minutes, half hour, or any other frequency.

FIG. 5D illustrates a study session feature. This feature allows the parent to schedule specific times of the day and specific recurring days when certain features will be active or inactive. For instance, the parent can schedule a recurring study session during school hours on weekdays, during which the app blocking will be deactivated and only study reminders will be delivered. In other examples, the parent may schedule the device to activate app blocking after school hours, during the evening, or during any other time period he or she chooses.

FIG. 5E illustrates a study break feature. The study break feature may allow the child to pick a time when the app blocking feature will be disabled for a short duration. For instance, the child may be granted the ability to pause the app blocking feature two times per day for fifteen minutes, for ten minutes each hour, or for any other amount or duration the parent chooses. Once the study break expires, the app blocking feature may resume, requiring the child to complete a task in order to access certain applications.

FIG. 5F illustrates the passes feature. This feature may allow the child to skip answering a question that is triggered by app blocking, thereby allowing the child to proceed directly to the application he or she wants to use. Passes may be used as a “skip” for the purposes of analytics of the child's progress, so as to not affect the child's performance metrics while still allowing the child to access the sought after application. The child may be granted a specific number of passes each day, week, or other duration. Further, passes may be granted upon completion of certain tasks, such as answering a given number of questions correctly, answering specific questions correctly, or completing a larger task (finishing a topic or module).

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A networked system comprising:
a user device comprising at least a first memory, a first transceiver, and a first user interface, wherein the first memory contains software code for operating:
a plurality of entertainment-based applications; and
an access-enabling application that selectively provides user access to a restricted application from among the plurality of entertainment-based applications upon completion of at least a first task relating to an educational goal;
a server device communicatively coupled to the user device configured to:
provide one or more questions related to an educational goal to the user device for presentation on a user interface; and
a control device in communication with the server device configured to:
select the restricted application;
select the educational goal; and
present progress data corresponding to usage of the access-enabling application by the user device.

2. The networked system of claim 1, wherein the control device and the user device are separate computing devices.

3. The networked system of claim 1, wherein completion of the first task is accomplished by correctly answering a presented question from the one or more questions related to an educational goal.

4. The networked system of claim 1, wherein the access-enabling application is further configured to:
provide, via the user device, access to a subset of available functions of the restricted application prior to completion of the first task; and
upon completion of the first task, provide full access to the available functions of the restricted application.

5. The networked system of claim 4, wherein the restricted application comprises a communication application, and wherein the subset of available functions comprises a list of allowed contacts that may be contacted prior to completion of the first task.

6. The networked system of claim 1, wherein the access-enabling application is further configured to, after a predetermined time period following completion of the first task, restrict access to the restricted application until completion of a second task.

7. The networked system of claim 1, wherein the server device is further configured to:
receive submitted questions from various system users;
sort the submitted questions according to educational goals; and
offer the questions for selection by the control device to be presented to the user device.

8. The networked system of claim 1, wherein the server device is further configured to provide the selected question to the user device based on the progress data corresponding to usage of the access-enabling application.

9. The networked system of claim 1, wherein the server device is further configured to:
receive usage data from a plurality of user devices corresponding to usage of a corresponding plurality of access-enabling applications; and
provide the selected question to the user device based on the usage data from the plurality of user devices.

10. The networked system of claim 1, wherein the server device is further configured to provide a list of suggested questions to the control device, wherein the list of suggested questions is determined based on the progress data corresponding to usage of the access-enabling application by the user device.

11. The networked system of claim 10, wherein the progress data comprises data selected from a list comprising (i) a percentage of correct answers, (ii) times corresponding to a beginning and a completion of the first task, (iii) location data corresponding to the beginning and the completion of the first task, and (iv) the restricted application for which access was selectively provided.

12. The networked system of claim 1, wherein the user device is further configured to:
provide access to study materials corresponding to the selected educational goal responsive to receiving an incorrect answer to the question or upon request of the user.

13. The networked system of claim 1 further comprising a plurality of user devices, wherein:
the server device is further configured to receive progress data corresponding to usage of the access-enabling application for each of the plurality of user devices; and
the control device is further configured to:
receive progress data corresponding to usage of the access-enabling application for the plurality of user devices; and
determine separate tasks to be completed for each of the plurality of user devices based in part on the progress data received from each of the plurality of user devices, wherein completion of a given task by a given user device enables the access-enabling application to provide full access to the restricted application.

14. A method of controlling usage of a user device comprising:
receiving, by a user device, a selected question related to an educational goal;
receiving, by the user device, input corresponding to an attempt to access a restricted application determined from among a plurality of entertainment-based applications on the user device; and
selectively providing access, by an access-enabling application of the user device, to the restricted application upon completion of at least a first task relating to the educational goal,
wherein the restricted application is determined by a control device, and wherein the educational goal is determined by the control device.

15. The method of claim 14, wherein completion of the first task comprises receiving a correct answer to the selected question.

16. The method of claim 15, further comprising:
providing access to a subset of available functions of the restricted application prior to completion of the first task; and
upon completion of the first task, providing full access to the available functions of the restricted application.

17. The method of claim 16, wherein the restricted application comprises a communication application, wherein the subset of available functions comprises a list of allowed contacts that may be contacted prior to completion of the first task, and wherein the subset of available functions of the restricted application is determined by the control device.

18. The method of claim 15, wherein the selected question related to the educational goal is determined based on progress data corresponding to usage of the access-enabling application.

19. The method of claim 15, further comprising:
transmitting progress data corresponding to usage of the access-enabling application from the user device to a server device,
wherein the progress data comprises data selected from a list comprising (i) a percentage of correct answers, (ii) times corresponding to a beginning and a completion of the first task, (iii) location data corresponding to the beginning and the completion of the first task, and (iv) the restricted application for which access was selectively provided.

20. The method of claim 15, further comprising:
providing access to study materials corresponding to the selected educational goal responsive to receiving an incorrect answer to the question or upon request of the user.

21. The networked system of claim 1, wherein completion of the first task is determined by the scoring of a quiz relating to the education goal and the user interactions with the access-enabling application while the user is taking the quiz.

22. The networked system of claim 1, wherein the access-enabling application periodically presents study reminders through the user device that temporarily interrupt use of the restricted application after the first task has been completed.
